(19) United States
(12) Patent Application Publication
(10) Pub. No.: US 2007/0040345 A1
(43) Pub. Date: Feb. 22, 2007

(54) Watts strut

(75) Inventors: Uwe Hardtke, Schifferstrasse (DE); Rene Kratz, Stuttgart (DE); Stefan Schwarz, Luenen (DE); Ulrich Zech, Magstadt (DE)

Correspondence Address: CROWELL & MORING LLP;INTELLECTUAL PROPERTY GROUP, P.O. BOX 14300, WASHINGTON, DC, 20044-4300, US

(73) Assignee: DaimierChrysler AG, Stuttgart (DE)

(21) Appl. No.: 10/560,382

(22) PCT Filed: Jun. 5, 2004
(86) PCT No.: PCT/EP04/06093

§ 371 Date: Sep. 19, 2006

(30) Foreign Application Priority Data
Jun. 14, 2003 (DE) 103 26 858.8

(51) Int. Cl. B60G 7/00; B60G 11/00; F16F 1/26

(52) U.S. Cl. 280/124.164; 267/36.1; 267/260; 280/124.134

(57) ABSTRACT

A Watts strut having a log strut body with a bearing bush arranged at one axial end thereof The strut body is produced by hydroforming, and is twisted on itself about a longitudinal axis.

### BACKGROUND OF THE INVENTION

The present invention relates to a Watts strut having a long hydroformed, one piece strut body with a bearing bush arranged at one axial end.

Watts struts as stabilizer members for a chassis of a vehicle are already known. The Watts strut is part of the Watts linkage, which is basically used in rigid-axle vehicles in order to reduce lateral movements of the rigid axle. In the Watts linkage a lever, which is rotatably supported at the center, is supported on the differential, for example, and is carried to either side by Watts struts of equal length fixed to the vehicle body. This articulation only permits a precise vertical movement of the lever. In alternative embodiments the lengths of the two Watts struts may differ from one another.

DE 100 14 603 C2 discloses a Watts strut which is formed from a long strut body as a profile section. In cross-section, the strut body is, at least axially in sections, open on one side and, in the longitudinal direction, is joined from at least two profiled parts arranged axially in tandem. The profiled parts are arranged partially overlapping one another in the longitudinal direction and are joined together in the overlap area.

DE 198 43 825 A1 discloses a suspension arm, which is produced from a tubular body, which in a first step of the method is initially preformed at one end by means a cold-forming process in order to produce a journal-shaped shoulder. The journal-shaped shoulder is formed and then bent towards this end before the shape of the suspension arm is formed by means of hydroforming. The journal-shaped shoulder is formed separately from the shape of the suspension arm.

U.S. Pat. No. 6,149,198 A1 discloses a control arm arrangements which comprises hollow formed parts, which are formed with varying cross-sections. The formed parts formed by hydroforming are joined to one another. Separate fixing parts such as bearing bushes are welded or soldered onto the formed parts.

U.S. Pat. No. 6,471,226 B1 discloses a chassis part, which comprises at least two hydroformed hollow formed parts. The one formed part has a connecting area, by ways of which it is inserted into a corresponding connecting area of the other formed part and connected thereto.

DE 197 20 133 A1 discloses a motor vehicle rear axle in the form of a compound link rear axle, whose axle carrier area with transitional area is formed by trimming of a by a hydraulic hydroforming process. The workpiece formed in this way is then welded to longitudinal control arms.

An object of the present invention is to provide a Watts strut which can be produced to a high quality with low production costs.

According to the invention this object has been achieved by twisting the strut body on itself about a longitudinal axis.

One advantage is that Watts struts can now be formed with high precision and have only a relatively low weight. Various joining operations are dispensed with and problems of corrosion, which can occur with welded parts, are eliminated. These advantages accrue in particular when additional structures, such as a bush for the accommodation of a rubber bearing, are integrally formed in the hydroforming process. A complex Watts strut geometry is furthermore possible.

### BRIEF DESCRIPTION OF THE DRAWINGS

FIGS. 1a and 1b show a left-hand and a right-hand respectively, Watts strut with a suspension link eye and fixing part, and

FIG. 2 is a perspective view which shows two Watts struts in the fitted position.

### DETAILED DESCRIPTION OF THE DRAWINGS

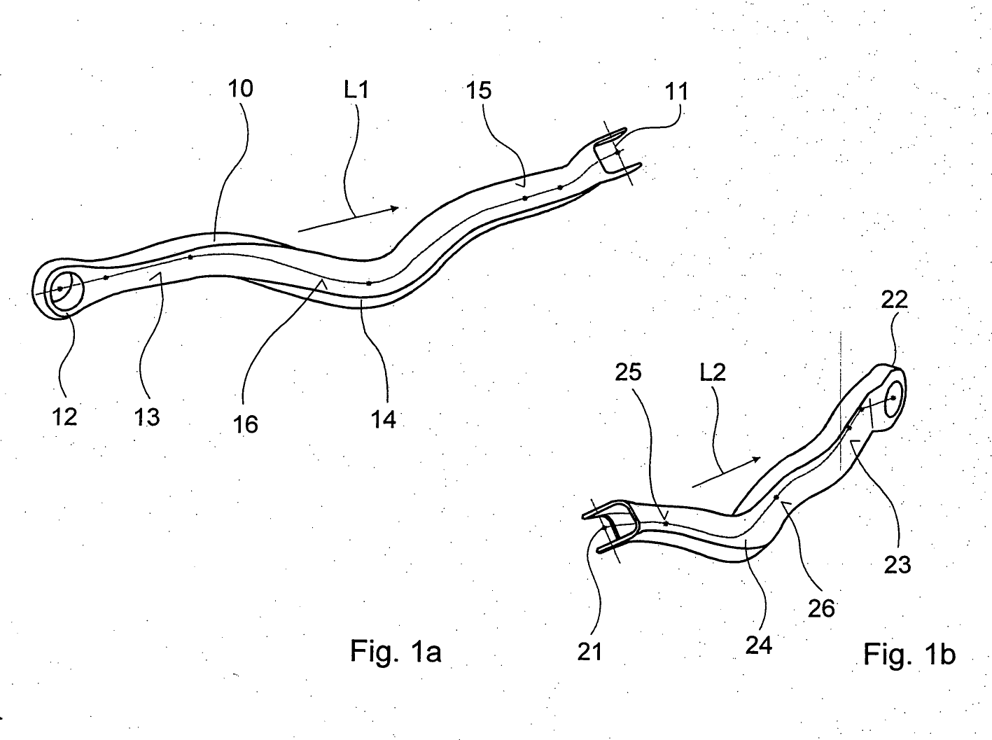

A left-hand (a) and a right-hand Watts strut are depicted respectively in FIGS. 1a and 1b. The left-hand Watts strut 10 has a long, twisted strut body, at one axial end of which a bearing bush 12 is arranged, and at the other axial end of which a U-shaped end section 11 is arranged. The strut body extends along a longitudinal axis L1. The bottom of the U-shaped end section 11 is formed by the Watts strut itself. The two legs of the U-shaped end section 11 pointing away from the strut body in the direction of the longitudinal axis L1 each have a hole which is provided for fixing to a connecting device and which connects the two Watts struts 10, 20 together. The cross-section of the strut body is approximately rectangular. One face 16 of the strut body has a first face section 13 close to the bearing bush 12 and a second face section 15 close to the U-shaped end section 11. Along the longitudinal axis L1 the strut body is twisted by approximately 90° about the longitudinal axis L1, so that the face 13 at the bearing bush 12 is aligned approximately perpendicularly to the corresponding face 15 at the U-shaped end section 11. The strut body has a bend 14 approximately in the middle, so that the strut body is there separated at an angular distance from the longitudinal axis L1.

The right-hand Watts strut 20 in FIG. 1b is of similar configuration and extends along a longitudinal axis L2 with a long, twisted strut body, at one axial end of which a bearing bush 22 is arranged and at the other axial end of which a U-shaped end section 21 is arranged. The right-hand Watts strut 20 also has a bend 24, so that at the bend 24 the strut body is separated at an angular distance from the longitudinal axis L2. A twisting of the right-hand Watts strut 20 is discernible at the face 26, which has a face section 23 at the bearing bush 22 and a face section 25 at the U-shaped end section 21, the sections being opposed at a finite angle to one another. The Watts struts 10, 20 according to the present invention have a relatively low weight, since they do not need any internal stabilizing elements, and joining flanges and the like are eliminated.

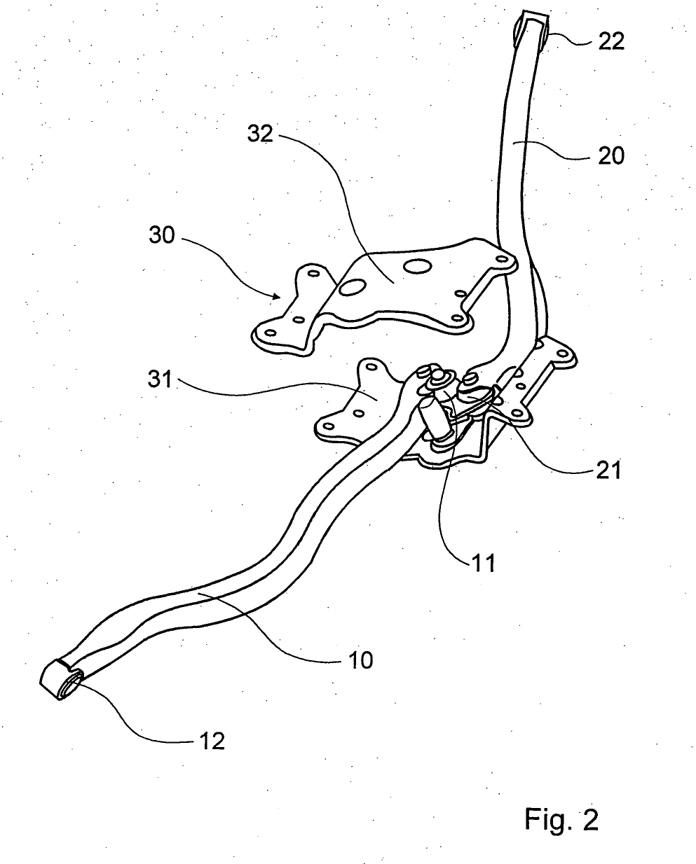

FIG. 2 shows an exploded view of the two Watts struts 10, 20 with a connecting device 30 in the fitted position. The U-shaped end sections 11, 21 are united and are fixed in the connecting device 30 to a lower shell 31 and an upper shell 32. The two shells 31, 32 envelop the end sections 11, 21 of the two Watts struts 10, 20. At the same time both end sections 11, 21 are articulated on pivots in the connecting device 30. The connecting device 30 is finally fixed approximately centrally to an axle or a differential in the usual way, and the outer bearing bushes 12, 22 are in the usual way intended for bearing support on a vehicle body arranged on both sides of a vehicle.

Watts struts 10, 20 according to the invention may, of course, also have a different geometry.

For producing the Watts strut 10, 20 according to the inventions a hollow blank workpiece, for example a tubular or profiled section, is preferably expanded in a forming tool through the action of a fluid pressure acting inside the workpiece and by forces applied externally to the ends of the workpiece. These forming stresses cause the wall of the blank workpiece to conform to the enveloping forming tool. In order to avoid folding and cracking, a suitable axial force acts on the workpiece simultaneously with the internal pressure. A workpiece geometry corresponding to this shape is produced.

Suitable materials that can be worked by this method include all materials having sufficient deformability, especially all cold-formable materials which are also used for deep-drawing or extrusion. The use of light metals, particularly aluminum or aluminum alloys, is especially advantageous, because this permits a further weight-saving.

Where aluminum alloys are used for a currently preferred Watts strut 10, 20 the relatively low deformability compared to steels and the much greater roughening due to the larger grain size must be taken into consideration. The use of hot age-hardening alloys is particularly advantageous because of the scope which they afford for adjusting the strength distribution in the workpiece in advance through a simple heat treatment, while the workpiece blank is yet unformed, so that in the forming of the (cooled) workpiece the material flow can be influenced to a significant degree. The lower yield stress of aluminum alloys compared to steel moreover affords the facility for optimizing the material flow and hence the forming process through even small additional forces, generated by an external flow, for example. Highly complex geometries of the preferred Watts struts 10, 20 can thereby be achieved.

Among other things, a precise knowledge of an objective process control, via which the application of the internal pressure and the mechanical stresses are controlled with a view to the desired outcome of the forming process, is advantageous for the use of this method. This is suitably optimized through repeated simulations of the hydroforming process.

The technology of hydroforming is capable of advantageously meeting the requirements for lightweight vehicle construction. Hydroforming offers a number of advantages over the conventional manufacture of such workpieces. It is now possible to produce load-adjusted, cross-sectional shapes along straight or curved component axes without strength or rigidity-reducing joints, while at the same time saving workpiece material. It is furthermore now possible to produce parts with a high degree of integration, saving the need for joining operations and thereby making it possible to eliminate joining flanges and to dispense with tolerance-compensating measures. In addition, the method may also be combined with other machining processes, such as perforation and bending under internal pressure. Workpieces can furthermore be produced with great dimensional and geometrical accuracy without the delay incurred due to welding influences.

1.-6. (canceled)

7. A Watts strut, comprising a relatively long one-piece hydroformed strut body with a bearing bush arranged at one axial end thereof, wherein the strut body has a configuration of being twisted on itself about a longitudinal axis.

8. The Watts strut as claimed in claim 7, wherein a central area of the strut body has a bend which is separated at an angular distance from the longitudinal axis.

9. The Watts strut as claimed in claim 7, wherein one axial end of the strut body has an integral hydroformed bearing bush.

10. The Watts strut as claimed in claim 7, wherein a central area of the strut body has a bend which is separated at an angular distance from the longitudinal axis.

11. The Watts strut as claimed in claim 7, wherein the strut body is formed from a light metal.

12. The Watts strut as claimed in claim 7, wherein the strut body is formed from steel.

13. The Watts strut as claimed in claim 7, wherein the strut body is formed from a hot age-hardening aluminum alloy.

14. A method of making a Watts strut as claimed in claim 7, comprising twisting the strut body on itself about the longitudinal axis.

15. The method of claim 14, further comprising forming the bend so as to be separated at the angular distance from the longitudinal axis.
